(19) United States
(12) Patent Application Publication
(10) Pub. No.: US 2004/0003855 A1
(43) Pub. Date: Jan. 8, 2004

(54) Sewer plug

(75) Inventors: Richard L. Dees, Meridian, ID (US); Zachary Doerzaph, Blacksburg, VA (US); Chris A. Reeder, Boise, ID (US); Mark E. Paulus, Pullman, WA (US); Quincy O'Donnell, (US)

Correspondence Address: DYKAS, SHAVER & NIPPER, LLP, P.O. BOX 877, 802 WEST BANNOCK STREET, SUITE 405, BOISE, ID, 83701, US

(73) Assignee: City of Boise, Boise, ID

(21) Appl. No.: 10/189,282

(22) Filed: Jul. 3, 2002

(51) Int. Cl. F16L 55/12

(52) U.S. Cl. 138/93; 138/91

(57) ABSTRACT

The invention is a sewer plug which is inserted into a sewer main line and positioned over a tributary or sewer feed line coming into the sewer main line. The sewer plug has an inflatable collar which is inflated once the device is in place. The inflation of the device causes blockage of the feeder line, but allows the flow through the sewer main line to continue. The device is positioned using lines attached to the device which are pulled from an upstream and a downstream manhole access. The device can be positioned by moving at a measured distance between the two manhole accesses, or by the use of a video camera, which can be attached to the device, and which enables a user to view the sewer tributary line during positioning. When the device is no longer used, it may be deflated and pulled out of the sewer main line.

### BACKGROUND OF THE INVENTION

1. Field of the Invention

The present invention generally relates to municipal sewer devices, and more particularly relates to devices for blocking sewer lines.

2. Background Information

Municipal sewer systems are typically built to be gravity flow systems. The slope of pipes is used to carry wastewater from homes and businesses to treatment plants. These systems may have lift stations to lift water from the bottom of one gravity run to begin another gravity based section of the system. Since sewage systems are gravity systems, they are not pressurized and there is no need for flow control through any type of a valve. Thus, these municipal sewer systems typically do not have valves that would stop the flow from any source such as a home or business. This can lead to a problem when a tributary line to a main sewer line needs to be shut off. One situation in which a sewer line might need to be shut off is to temporarily block the flow while a main sewer line is being repaired. Another reason might be to shut off a particular user until the user fees are paid.

There are no means currently available for shutting off the tributary line without excavation. To excavate a line for shut off, the tributary line would be unearthed, cut open and a plug would be inserted. This process requires that a hole be cut in the street, which disrupts traffic and consumes man-hours, heavy machinery and materials. The cost of this process can be upwards of $10,000 per excavation. Once the tributary line is to be opened, the street would have to be dug up again and the plug removed. Municipal ordinances can make such an excavation very difficult, and obtaining permission to dig on private property complicates this.

However, a municipality can loose hundreds of thousands of dollars from people or businesses ignoring their sewer bill. One way to collect such payments would be to temporarily block the flow of a tributary line from a particular house, business or building. If this could be done in an economical fashion, without excavation, every municipality would have a tool with which to eliminate unpaid sewer bills.

One of the requirements of a device that would be used to shut off a tributary line would be that it would operate within the existing sewer system. Sewer systems typically have main lines from four to twelve inches in diameter or larger. The sewer main lines can be made of PVC, asbestos concrete, clay or other materials. The tributary plug would have to have a fairly low leak rate so that the tributary is effectively blocked. It should not affect other customers in the vicinity of the plug so that upstream overflows would not occur. Ideally, it would be easily installed, such as by two people in approximately an hour of time. In addition, it would leave no damaging effects on the sewer system.

### SUMMARY OF THE INVENTION

These and other objects are achieved by the sewer plug of the present invention. The sewer plug of the present invention includes a sleeve body. The sleeve body is generally cylindrical in shape with a first end and a second end, which remain open during installation, use and removal of the sewer plug. The sleeve body can be rigid and made from such materials as PVC, metal, fabric or other plastic. The sleeve body can also be flexible, such as a sleeve body made of canvas, neoprene or other fabric. Attached to the sleeve body is an inflatable collar, which can take a number of configurations. The function of the inflatable collar is to inflate after the sewer plug is in position, and, by its inflation, block a tributary or feeder line into a sewer pipe. A donut shaped inflatable collar would be placed so as to surround the inlet of the feeder line into the main line, and seal it against a rigid sleeve body. As such, flow from the tributary line is obstructed while preserving mainline flow through the sleeve body. A generally spherical shaped inflatable collar can also accomplish such a sealing of the feeder line. The inflatable collar can also take the form of one or more inflatable rings which circle the sleeve body.

In one version of the device, two inflatable rings are positioned on the sleeve body so as to circle the sleeve body. They are placed in position over the feeder line or tributary line inlet so that flow from the feeder line is trapped against the outside of the sleeve body and cannot enter the main sewer line. Such a configuration can be used with a rigid or flexible sleeve body.

Attached to the inflatable collar is an air source. The air source can be an air compressor located outside of the sewer main line, such as a compressor at ground level. Such a compressor would be connected by an air hose to the inflatable collar. The air source could also be a compressed gas cylinder which is attached to the inflatable collar and may be positioned anywhere in the system. Such an air canister could be attached to the sleeve body, or could be any distance from the inflatable collar and attached by an air line.

The device also includes an air release for releasing air and deflating the inflatable collar.

The device also has at least one line attachment loop attached to the sleeve body for use in positioning the sewer plug in the sewer main line so that the sewer feed line can be blocked. The device can have a first line attachment loop at one end of the sleeve body and a second line attachment loop at a second end of the sleeve body, each with lines attached. The lines could be metal cables, ropes made of suitable material such as nylon, flat plastic or metal tape, or any suitable line made of material which would function for positioning and retrieving the sleeve body.

The device is used by accessing the main sewer line through a manhole or other access point. The device is placed in the main sewer line via the manhole, and moved downstream to the next manhole or until aligned with the tributary line to be blocked. This can be accomplished by floating a line downstream of the device, and pulling it downstream or to the next downstream manhole. Once in the sewer line at the next downstream manhole, the device can be pulled upstream into position over the selected feeder or tributary line. The positioning over the tributary line can be accomplished by measuring the distance from the manhole covers to the tributary line, by the use of a video camera, or by measuring the flow until the flow from the tributary line is stopped.

Once the sewer plug is in position, the inflation collar is inflated by activating the compressor or the compressed air canister. Once inflated to the desired pressure, inflation ceases and the tributary line is blocked. The inflation collar remains inflated until the device is ready for removal, at which time it can be deflated by using an air release. Deflation can be accomplished by simply opening the air line at the surface air compressor, or it can be a mechanical device for releasing the air from the inflation device. Once deflated, the sewer plug can be pulled up or downstream to a manhole and removed from the sewer line. The device can include a reserve tank which contains compressed air and a regulator, which would typically be located in the manhole and would assure that pressure is maintained during the plug's installation.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a perspective view of the sewer plug.

FIG. 2 is a side, cross-sectional view of the sewer plug as it is being installed.

FIG. 3 is a side view of the sewer plug.

FIG. 4 is a side, cross-sectional view of the sewer plug.

FIG. 5 is an end view of the sewer plug.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

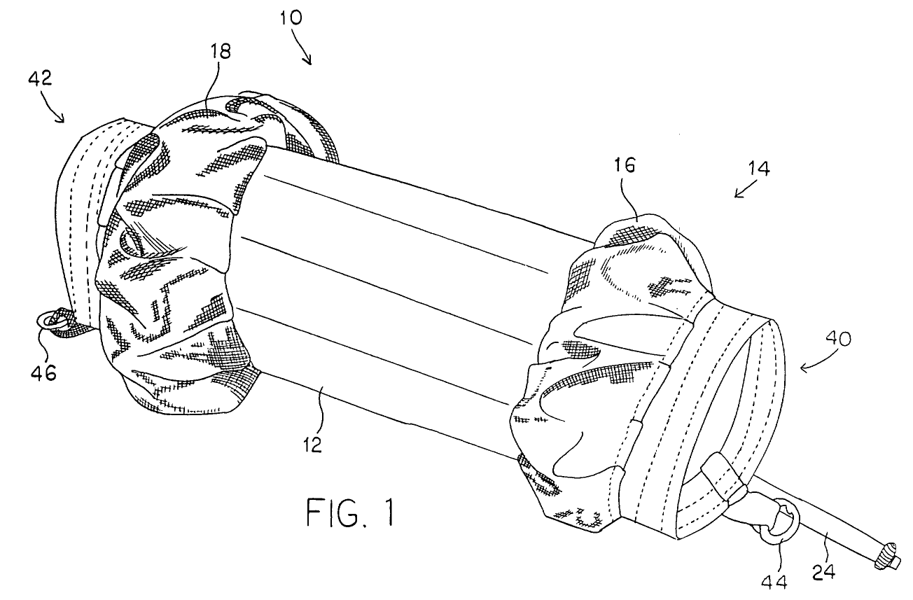

A preferred embodiment of the sewer plug of the invention is shown in FIGS. 1-5. FIG. 1 shows the sewer plug of the invention with a sleeve body 12, a first end of sleeve body 40, a second end of sleeve body 42, a first inflation ring 16, and a second inflation ring 18. The first and second inflation rings 16, 18 comprise the inflatable collar 14. Although the installed collar can take a number of configurations, in this embodiment, the configuration is of a first and a second inflation ring. In this embodiment, the inflation rings 16, 18 are formed of inner tubes held within a fabric pouch. The fabric pouch may be zippered to allow easy replacement of the inner tubes. The inner tubes are sized for the diameter of the sewer main line pipe that they are inserted in. Possible sources of inner tubes can be wheelbarrow inner tubes, small bicycle inner tubes, or other inflatable inner tubes.

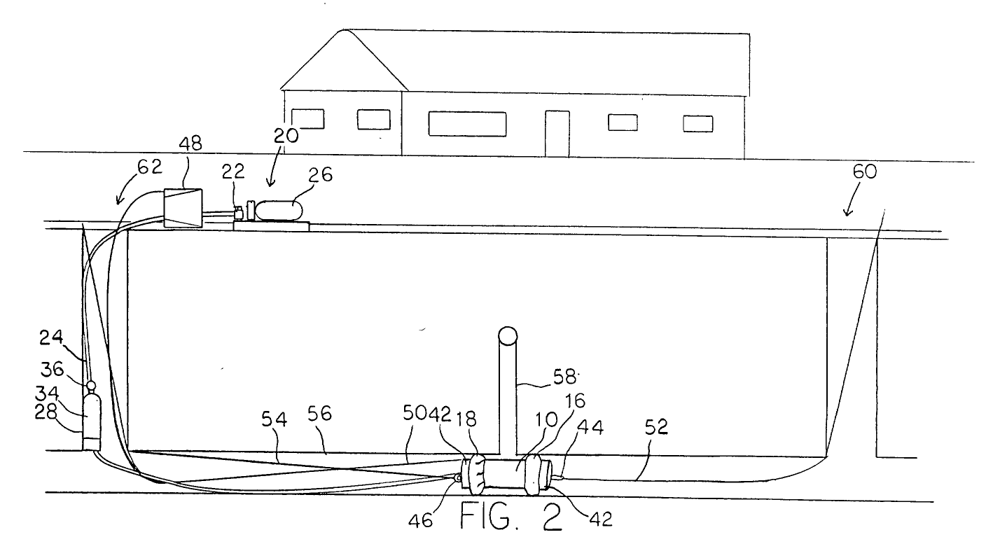

FIG. 2 shows the sewer plug 10 of the invention being installed and in use in a sewer installation. The device 10 is lowered into a manhole access 60 and is positioned over the sewer feeder line 58. This can be accomplished by allowing a second positioning line 54 to be carried downstream until it can be retrieved in the downstream manhole access 62. Then, the second positioning line 54 would be used to pull the sewer plug 10 downstream in the sewer main line 56 while the first positioning line 52 was played out from the manhole access 60. The sewer plug 10 would be positioned over the sewer feeder line 58 either by moving it a measured distance, by the use of a video camera 48, or by measuring the change in flow at different positions. The video camera would typically not be attached to the sleeve body, but could be.

If not attached, the video camera would have its own drive system, which would independently move the video camera into a position to view the placement of the device in the main sewer line. Video camera 48 has a video cable 50 that is attached to the sleeve body 12 of the device 10 and can be used to position the sleeve body 12. Once in position, the first inflation ring 16 and the second inflation ring 18 are inflated.

In the embodiment shown, an air compressor 26 is utilized which has an air release 22 and an air hose 24 going to the device. Although shown in the figures as being above ground, the air compressor or air source could also be suspended in the manhole to keep it out of the way. Another option for an air source is a compressed air canister 28 which is also shown in the figure. The compressed air canister 28 can also serve as a reserve tank 34 which would serve to maintain a selected pressure in the first inflation ring 16 and second inflation ring 18 when the compressor 26 has been disconnected. The reserve tank 34 would utilize a regulator 36 to deliver the selected pressure. Fifty pounds of pressure in the first and second inflation rings 16, 18 has been found to be suitable for sealing off the sewer feeder

When the device is to be removed, the inflation collar 14 is deflated by use of the air release 22 on the air hose 24. The sewer plug 10 is then retrieved by using the first positioning line 52 or the second positioning line 54 through either of the manhole accesses.

FIG. 3 shows a side view of the sewer plug 10 of one embodiment of the present invention. In this configuration, the first inflation ring 16 and second inflation ring 18 are enclosed within fabric pouches which have pleats to allow for expansion of the inflation rings. In this configuration of the device, the sleeve body 12 is made of a waterproof fabric. Neoprene fabric has been proven to work well, and canvas has also been utilized. With canvas, there is some seepage through the fabric, but the leakage is slow enough that the plug still functions very well. However, with waterproof fabric such as Neoprene, there is much less leakage. The fabric pouches surrounding the first inflation ring 16 and the second inflation ring 18 are provided to stabilize and position the inflation rings, and to protect them from abrasion inside the sewer main line 56. Shown in FIG. 3 is the air hose 24, the first attachment ring 44, and second attachment ring 46. Although the embodiment shown in the figures is made of a flexible fabric, a sleeve body made of a rigid material such as a section of PVC pipe, another plastic, or metal tube could also be utilized.

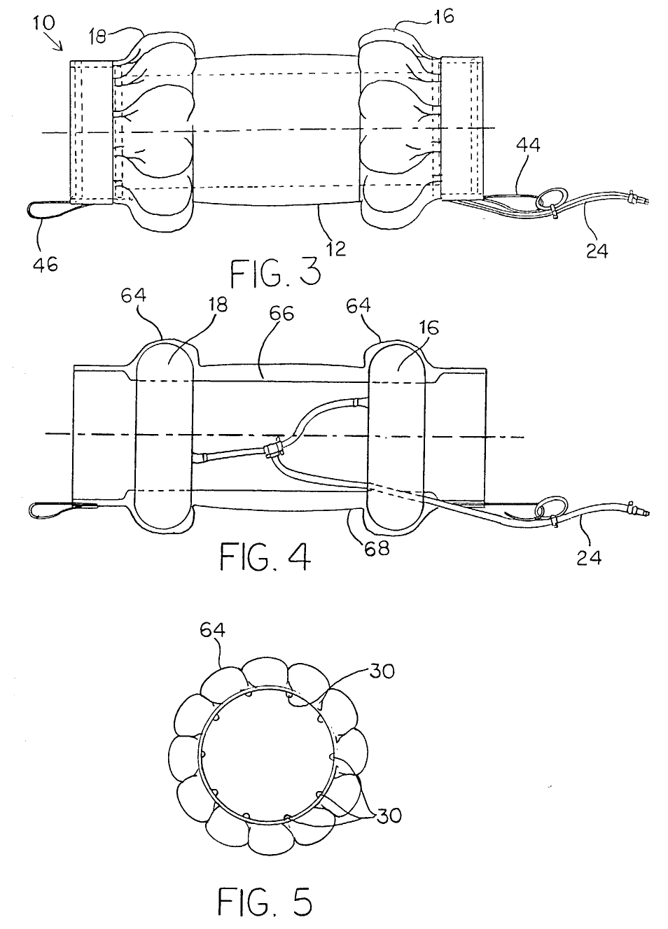

FIG. 4 shows a cutaway view of this preferred embodiment of the device, showing the first inflation ring 16 and the second inflation ring 18 inside of the fabric pouch 64. The two inflation rings are joined by an air hose 24 which is teed to feed into the valve stem of each inflation ring. This version of the device shows an inner layer 66 and an outer layer 68 of fabric. The first inflation ring 16 and the second inflation ring 18 are positioned between the two layers of fabric. The air hose 24 is also positioned between the two layers of fabric.

FIG. 5 shows an end view of the device showing stiffening rods 30 which are utilized in the flexible fabric version of the device. Stiffening rods 30 fit into sleeves formed between the inner the inner layer 66 and the outer layer 68 of fabric of the device. These can be fiberglass rods, wooden rods, metal rods, plastic rods, or rods made of other suitably stiff material. In this particular configuration of the device, which is sized for eight-inch pipe, the stiffening rods are approximately three-eighths inch in diameter and approximately twenty-four inches long, which is the approximate length of the device. Other sizes of sewer plugs 10 would be utilized with other dimensions of sewer main lines 56.

While there is shown and described the present preferred embodiment of the invention, it is to be distinctly understood that this invention is not limited thereto but may be variously embodied to practice within the scope of the following claims.

From the foregoing description, it will be apparent that various changes may be made without departing from the spirit and scope of the invention as defined by the following claims.

I claim:

1. A sewer plug for use in a sewer main line for blocking flow of a sewer feeder line without obstructing flow in said sewer main line, which comprises:
a sleeve body with an open first end and an open second end, for insertion into a sewer main line;
an inflatable collar attached to said sleeve body which is configured for inflation to block flow from a sewer feeder line opening into said sewer main line;
an air source operatively connected to said inflatable collar, for inflating said inflatable collar;
an air release for deflating said inflatable collar;
a line attachment loop attached to said sleeve body, for use in positioning said sewer plug in said sewer main line adjacent to said sewer feeder line;
wherein said sewer plug is adapted for positioning adjacent said feeder line opening into said sewer main line by use of one or more lines attached to said line attachment loop, so that flow from said feeder line is blocked upon inflation of said inflatable collar, while flow through said sleeve body remains unobstructed, and said inflatable collar may be deflated to allow removal of said sewer plug by use of said one or more lines attached to said line attachment loops.

2. The sewer plug of claim 1 in which said inflatable collar comprises a first and a second inflation ring, which are configured to be positioned upstream and downstream from said feeder line inlet into said sewer main line.

3. The sewer plug of claim 1 which further includes an air hose attached to said inflatable collar which delivers air from said air source.

4. The sewer plug of claim 1 in which said air source is an air compressor located outside said sewer main line.

5. The sewer plug of claim 1 in which said air source is a compressed air canister attached to said sleeve body.

6. The sewer plug of claim 1 in which said sleeve body is cylindrical in shape.

7. The sewer plug of claim 5 in which said sleeve body is rigid.

8. The sewer plug of claim 1 in which said sleeve body is made of a flexible fabric.

9. The sewer plug of claim 7 which further includes stiffening rods.

10. The sewer plug of claim 1 which said air source further includes an air reserve tank, to maintain air pressure in said inflatable collar during use of said sewer plug.

11. A sewer plug for use in a sewer main line for blocking a sewer feeder line without obstructing said sewer main line, which comprises:
a sleeve body with an open first end and an open second end, for insertion into a sewer main line;
a first inflation ring attached to said cylindrical sleeve body adjacent to said first end, for inflation in said sewer main line adjacent downstream of a chosen sewer feeder line;
a second inflation ring attached to said cylindrical sleeve body adjacent to said second end, for inflation in said sewer main line adjacent upstream of said chosen sewer feeder line;
an air source operatively connected to said first and second inflation rings, for inflating said first and second inflation rings;
an air release for deflating said first and second inflation rings;
a line attachment loop attached to said cylindrical sleeve body, for use in positioning said sewer plug in said sewer main line;
wherein said sewer plug is adapted for positioning over a feeder line entering said sewer main line by use of one or more lines attached said line attachment loop, so that said feeder line is centered between said first and said second inflation ring, and when said first and said second inflation rings are inflated, flow from said feeder line into said sewer main line is blocked, while flow from said first end of said cylindrical sleeve body to said second end of said cylindrical body remains unobstructed, and said inflation rings may be deflated to allow removal of said sewer plug by use of said one or more lines attached to said line attachment loops.

12. The sewer plug of claim 7 in which said sleeve body is of a flexible fabric.

13. The sewer plug of claim 8 in which said sleeve body further includes stiffening rods to prevent said fabric from folding.

14. The sewer plug of claim 7 in which said air source is a hose attached to a compressor located outside said sewer main line.

15. The sewer plug of claim 7 in which said air source is a compressed air canister operatively connected to said first and second inflation rings.

16. The sewer plug of claim 7 which further includes a first line attachment loop attached to said first end of said sleeve body and a second line attachment loop attached to said second end of said sleeve body, for attachment of one or more lines for use in positioning of said sewer plug.

17. The sewer plug of claim 7 which further includes a video camera attached to said sleeve body, for use in positioning said sewer plug.
